(19) United States
(12) Patent Application Publication
(10) Pub. No.: US 2026/0356422 A1
(43) Pub. Date: Nov. 12, 2026

(54) STEERING SYSTEM FOR A VEHICLE, IN PARTICULAR A UTILITY VEHICLE

(71) Applicant: KNORR-BREMSE SYSTEME FÜR NUTZ-FAHRZEUGE GMBH, München (DE)

(72) Inventors: Heinz Henning Hoppmann, München (DE); Markus Lichtenstein, Köln (DE); Martin Bernhard Leibbrandt, Bedburg (DE)

(21) Appl. No.: 19/474,524

(22) PCT Filed: Mar. 21, 2024
(86) PCT No.: PCT/EP2024/057556

§ 371 Date: Oct. 10, 2025

(30) Foreign Application Priority Data
Apr. 14, 2023 (DE) 102023109482.3

(51) Int. Cl. B62D 5/06; B62D 5/065

(52) U.S. Cl. CPC B62D 5/064; B62D 5/065

(57) ABSTRACT

An electrohydraulic steering system includes at least one steering gear, in particular a spindle steering gear; at least one first hydraulic, in particular electrohydraulic assembly, by means of which the steering gear can be supplied with hydraulic fluid and/or controlled; at least one second hydraulic, in particular electrohydraulic assembly can be connected to the steering gear; at least one operating parameter-detecting device for detecting at least one detectable assembly operating parameter of the first and/or the second hydraulic assembly; and at least one operating parameter-determining device, the operating parameter-determining device being designed and/or configured to determine and/or estimate, on the basis of at least one detectable assembly operating parameter, at least one further assembly operating parameter of the first and/or the second hydraulic assembly in the form of a determinable assembly operating parameter.

### DESCRIPTION

The present invention relates to an electro-hydraulic steering system for a vehicle, in particular a utility vehicle. Furthermore, the present invention relates to a vehicle with this electro-hydraulic steering system.

In conventional steering systems for utility vehicles, complex systems are formed with hydraulic elements or components such as sensors, filters, valves, and/or control elements such as actuators in the form of the steering gear that have a negative impact on system efficiency and system reliability. Steering systems for vehicles and especially for utility vehicles are already known in the prior art.

For example, the GB 2383433 A reveals a hydraulic conveying device, for example a power steering pump, which has a flow control valve between the pump and the supply and return lines. The valve contains a valve piston with a drilled, throttled extension, which can be moved against the preload force of the valve spring to open the conveyor chamber for return flow. The spring is mounted in a single part or multi-part valve housing between the valve piston and a drilled, throttled adjustment piston and can be changed in its preload by means of the adjustment piston.

It is the object of the present invention to advantageously develop an electro-hydraulic steering system of the type mentioned at the start, in particular in the sense that this system is more simply and more efficiently constructed, is less expensive and is less liable to faults.

According to the invention, this object is achieved by an electro-hydraulic steering system having the features of claim 1. According to this it is envisaged that an electro-hydraulic steering system is provided for a vehicle, in particular a utility vehicle, which has:
at least one steering gear, especially a spindle steering gear;
at least one first hydraulic, in particular electro-hydraulic, assembly by means of which the steering gear can be supplied with hydraulic fluid and/or controlled;
at least one second hydraulic, especially electro-hydraulic, assembly that can be connected to the steering gear;
   at least one operating parameter detection device for detecting at least one detectable assembly operating parameter of the first and/or second hydraulic assembly; and
   at least one operating parameter determination device, wherein
   the operating parameter determination device is designed and/or set up to determine and/or estimate at least one further assembly operating parameter of the first and/or second hydraulic assembly in the form of a determinable assembly operating parameter on the basis of at least one detectable assembly operating parameter.

The invention is based on the basic idea that an operating parameter determination device is provided, by means of which an operating parameter of the first and/or second hydraulic assembly can be determined and estimated by processing an operating parameter that can be transferred to it by the operating parameter detection device, for example as an input variable. This determination or estimation has the advantage that fewer assembly operating parameters actually have to be detected by sensor, so that the operating parameter detection device can be simpler because it has fewer corresponding sensors or is connected to them. This reduces the overall number of components in the steering system with the further advantages that the fault susceptibility and system complexity are reduced and yet all important or critical assembly operating parameters (such as pressures, temperatures, switching states of the valves, etc.) can still be determined as previously. A detectable assembly operating parameter can be understood in particular as an assembly operating parameter that can actually be detected directly by means of a corresponding sensor device, wherein the sensor device can be part of the operating parameter detection device or can be connected to it. Accordingly, a determinable assembly operating parameter can be understood to be in particular an assembly operating parameter that can be determined or estimated by means of the operating parameter determination device, wherein one or more detectable assembly operating parameters can serve as input variables, on the basis of which the determinable assembly operating parameter can then be determined or estimated accordingly. The first and second hydraulic assemblies are to be understood as separate assemblies, wherein they differ at least in a function and/or in a structural component. The steering gear can also be a part of the first or second hydraulic assembly.

In addition, it may be envisaged that the first hydraulic assembly has at least one hydraulic pump and at least one electric motor to drive the hydraulic pump, wherein the operating parameter detection device is designed and/or set up to detect at least one motor operating parameter of the electric motor and/or at least one pump operating parameter of the hydraulic pump, and wherein the operating parameter determination device is designed and/or set up to determine and/or estimate at least one determinable assembly operating parameter of the first and/or second hydraulic assembly on the basis of the detected motor operating parameter and/or pump operating parameter. The detection of the motor operating parameters can be carried out relatively easily and efficiently, so that the detection of this parameter is provided advantageously. In addition, certain motor operating parameters can have a high informative value with regard to other assembly operating parameters, so that the detection of this parameter is advantageous, which incidentally also applies to the pump operating parameter. Motor operating parameters and pump operating parameters can be special operating parameters of the first hydraulic assembly.

The motor operating parameter(s) can or may at least provide at least one electric motor current and/or at least one electric motor voltage and/or include at least one motor speed and/or at least one motor power and/or at least one motor torque. Since these motor operating parameters are highly informative with regard to other, in particular determinable, assembly operating parameters of the first and/or second hydraulic assembly, it is advantageous to detect this parameter or these parameters.

Furthermore, the pump operating parameter(s) can include at least one volume flow rate of the hydraulic fluid and/or at least one mass flow of the hydraulic fluid and/or at least one pump speed. Since these pump operating parameters can also have a high informative value with regard to other, in particular determinable, assembly operating parameters of the first and/or second hydraulic assembly, the detection of this parameter or these parameters is also advantageous. The hydraulic fluid can be in the form of a hydraulic oil suitable for steering gears.

In addition, it is conceivable that the detectable assembly operating parameter(s) could include at least one temperature of the hydraulic fluid in the first hydraulic assembly and/or at least one pressure of the hydraulic fluid in the first hydraulic assembly. Knowledge of the pressure in the first hydraulic assembly can be particularly advantageous for system safety, because the pressure generation takes place in this assembly and thus this pressure is a critical system variable. Based on the knowledge thereof, the operation of the first hydraulic assembly can be monitored reliably, so that detection of this operating parameter is particularly advantageous, which incidentally also applies to the detection of the temperature of the hydraulic fluid. In addition, the temperature detection can be particularly advantageous because it is the basis for determining or estimating many other determinable assembly operating parameters, so that a high informative value of other, in particular determinable, assembly operating parameters of the first and/or second hydraulic assembly may also be possible due to the temperature detection.

The detectable assembly operating parameter(s) may also include at least one temperature of the hydraulic fluid in the second hydraulic assembly and/or at least one pressure of the hydraulic fluid in the second hydraulic assembly. Knowledge of the pressure in the second hydraulic assembly can also be advantageous for system safety, because system-relevant components can also be arranged in this assembly. Based on the knowledge thereof, the operation of the second hydraulic assembly can be reliably monitored, so that the detection of this operating parameter can be particularly advantageous, which also applies to the detection of the temperature of the hydraulic fluid. In addition, temperature detection is particularly advantageous because it is the basis for determining or estimating many other determinable assembly operating parameters, so that a high informative value of other, in particular determinable, assembly operating parameters of the first and/or second hydraulic assembly may also be possible due to the temperature detection.

It can also be advantageous that the determinable assembly operating parameter(s) include(s) at least one pressure of the hydraulic fluid in the second hydraulic assembly. A pressure of the hydraulic fluid in the second hydraulic assembly can be advantageously determined or estimated as described above, so that the detection by sensor of the pressure of the hydraulic fluid in the second hydraulic assembly can be omitted, so that components such as sensors and corresponding lines can be omitted. According to this, system complexity or the number of components is reduced, wherein the pressure in the second hydraulic assembly is still predictable, even if not actually in a directly detected form.

The second hydraulic assembly can be in the form of a backup assembly and can have at least one hydraulic filter element and at least one backup switching valve. On the one hand, the backup assembly can ensure the steerability of the steering system even in the event of a total failure of the first hydraulic assembly, as it creates a short-circuit between the two working chambers of the steering gear, so that the hydraulic fluid can be moved between these two working chambers, which further ensures steering capability. The integration of the hydraulic filter element into the backup assembly is further advantageous in that the existing infrastructure due to the second hydraulic assembly can be assigned additional functions. During the inactive phases of the steering system, cleaning of the hydraulic fluid (as a hydraulic oil specified or suitable for steering gears) can thus be carried out very efficiently via the second hydraulic assembly by opening the backup switching valve. The second assembly is pressurized from the first assembly via the intermediate steering gear, and the hydraulic fluid can be filtered as a result. This arrangement is particularly advantageous because it can be exploited that recurring inactive phases occur in which the steering system does not require steering assistance by actuation by the steering gear. However, due to the fact that steering assistance is requested again at any time (especially during manual steering movements), the hydraulic pump of the first hydraulic assembly should always be kept in active operation, so that this active operation can also be used for filtering. This eliminates the need for an additional flushing valve or flushing pump, so that the steering system can be constructed even more simply, easily, and cost-effectively. Alternatively, it can also be provided that the steering gear is not switched or mounted between the first and second assemblies and that the first and second assemblies are directly connected to each other or are attached to each other and are attached to the steering gear as an entire assembly.

The determinable assembly operating parameter(s) may include at least one inlet pressure and/or outlet pressure of the hydraulic fluid at the hydraulic filter element. Monitoring of the inlet pressure and/or the outlet pressure at the hydraulic filter element is important because knowledge of this pressure can be used to determine the operating condition of the hydraulic filter element. Therefore, this pressure is a system-critical factor that should be monitored. Through the determination or estimation of the inlet pressure and/or outlet pressure of the hydraulic fluid at the hydraulic filter element, a pressure sensor (for example in the form of a differential pressure sensor) can be saved, so that the second assembly can be constructed more easily and reliably.

The operating parameter determination device may also be designed and/or set up to determine at least one inlet and/or outlet pressure at the hydraulic filter element, at least on the basis of the electric motor current, the volume flow rate of the hydraulic fluid and the temperature of the hydraulic fluid, as well as in particular the pump speed and/or the motor speed. In particular, the electric motor current, the volume flow rate of the temperature of the hydraulic fluid and the temperature of the hydraulic fluid are elementary parameters for determining and/or estimating the inlet and/or outlet pressure at the hydraulic filter element, so that their provision is particularly advantageous. In particular, the volume flow rate of the hydraulic fluid is an operating parameter that is preferably not detected or measured, but is determined or derived on the basis of the measured pump speed.

Furthermore, it may be provided that the operating parameter determination device is designed and/or set up to determine and/or estimate a filter operating condition, in particular the wear condition or the load condition of the hydraulic filter element, at least based on the inlet and/or outlet pressure at the hydraulic filter element. Monitoring the filter condition is very important for the functionality of the steering system, as it has a direct influence on the system safety of the steering system and is thus a critical system variable. The determination or estimation of the inlet pressure and/or outlet pressure at the hydraulic filter element is a very simple and advantageous facility, since the knowledge of this pressure provides reliable and yet easy-to-implement evidence regarding the operating status of the hydraulic filter element. The determination or estimation of the inlet pressure at the hydraulic filter element can be particularly advantageous.

Furthermore, it is conceivable that a parameter model is implemented in the operating parameter determination device, by means of which the operating parameter determination device is designed and/or set up to determine and/or estimate at least one assembly operating parameter of the first and/or second hydraulic assembly at least on the basis of a detectable operating parameter as an input variable. By means of this parameter model, an even better, more accurate and more flexible determination or estimation of at least one assembly operating parameter of the first and/or second hydraulic assembly is made possible, since the parameter model can be flexibly adapted to the boundary conditions of the steering system.

In addition, it is conceivable that circuit diagram data are implemented in the parameter model, which are associated with a hydraulic circuit of components and lines of the first hydraulic assembly and the second hydraulic assembly. By means of this circuit diagram data, a further improved, more precise and more flexible determination or estimation of at least one determinable assembly operating parameter of the first and/or second hydraulic assembly is possible, as the circuit diagram data enable even more detailed modelling of the boundary conditions of the steering system.

Furthermore, according to the invention, a vehicle is provided, in particular a utility vehicle, with at least one electro-hydraulic steering system as described above. All advantages and technical effects that can be achieved in connection with the steering system according to the invention can also apply individually or in combination to the vehicle according to the invention. In particular, the vehicle can be in the form of a utility vehicle.

Further details and advantages of the invention will now be explained in more detail based on the exemplary embodiment depicted in the drawing.

### IN THE FIGURE

FIG. 1 shows a schematic representation of a circuit of an exemplary embodiment of a steering system according to the invention.

FIG. 1 shows a schematic representation of a circuit of an exemplary embodiment of a steering system 100 according to the invention.

The electro-hydraulic steering system 100 for a utility vehicle has a steering gear 102 in the form of a spindle steering gear 102, which in turn has a steering gear housing 104.

The spindle steering gear 102 can be designed as a ball screw spindle steering gear, although other types of gearbox are also conceivable.

The electro-hydraulic steering system 100 also has a first hydraulic assembly 106, which is attached to the steering gear housing 104.

The first hydraulic assembly 106 is in the form of an electro-hydraulic assembly 106.

The electro-hydraulic steering system 100 also has a second hydraulic assembly 108, which is attached to the steering gear housing 104.

The second hydraulic assembly 108 is in the form of an electro-hydraulic assembly 108.

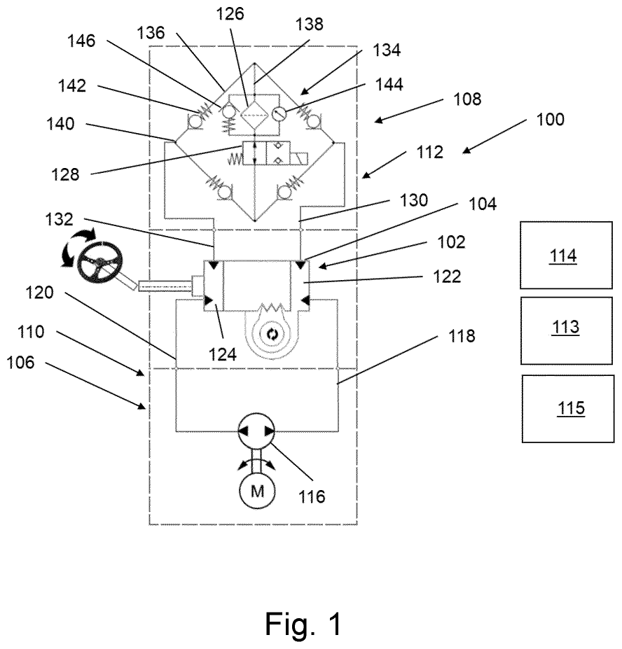

The attachment of the first and second hydraulic assemblies 106, 108 to the steering gear housing 104 can be realized by means of suitable flange connections, which, however, are not shown in the schematic depiction of FIG. 1.

Multiple components of the first hydraulic assembly 106 can be at least partially integrated into a first housing block 110 (made of solid block material as the initial structure).

Accordingly, multiple components of the second hydraulic assembly 108 can also be at least partially integrated into a second housing block 112 (made of solid block material as the initial structure).

However, it is also alternatively conceivable that the first hydraulic assembly 106 and the second hydraulic assembly 108 can each be integrated into a first and second assembly housing.

The first and second housing blocks 110, 112 may be constructed as structurally separate blocks in accordance with FIG. 1 and may be attached at different points to the steering gear housing 104.

For example, the first and second housing blocks 110, 112 can be attached to the steering gear housing 104 at opposite points (i.e. in a 180° orientation to each other).

It is also conceivable that the first and second housing blocks 110, 112 can also be attached to the steering gear housing 104 in a 90° or 270° orientation to each other.

According to an alternative design of the housing block of the steering system 100, one or more components of the first hydraulic assembly 106 and the second hydraulic assembly 108 can be at least partially integrated into a common housing block (not shown in FIG. 1).

The common housing block can comprise the first housing block 110 and the second housing block 112 or can be constructed from these two blocks 110, 112 or alternatively may also be designed as a one-piece housing block (made of solid block material as the initial structure).

However, it is also conceivable that the first hydraulic assembly 106 and the second hydraulic assembly 108 can each be integrated into a common assembly housing.

The steering system 100 also contains an operating parameter detection device 113 for the detection of one or more detectable assembly operating parameters of the first and second hydraulic assemblies 106, 108.

In addition, the steering system 100 has an electronic control and/or regulation device 114 for controlling and/or regulating the first and second hydraulic assemblies 106, 108.

Furthermore, the steering system 100 contains an operating parameter determination device 115.

The devices 113, 114 and 115 are depicted in FIG. 1 without connecting lines, wherein these devices 113, 114 and 115 are connected or connectable to the corresponding components of the first and second hydraulic assemblies 106, 108 by connecting lines.

It is also conceivable that the operating parameter detection device 113 and the operating parameter determination device 115 can be combined into a joint device.

Alternatively, it may also be provided that the operating parameter detection device 113 and/or the operating parameter determination device 115 are part of the electronic control and/or regulation device 114.

The first hydraulic assembly 106 has a hydraulic pump 116 and an electric motor M for driving the hydraulic pump 116 as components.

The hydraulic pump 116 is in the form of a double-acting or bidirectional hydraulic pump with a first and a second delivery direction.

Alternatively, it may also be conceivable that only a single-acting hydraulic pump is provided and is connected to the first and second lines 118, 120 via a suitable switching valve (not shown in FIG. 1) which, depending on the switching logic, connects the hydraulic pump 116 to the first or the second line 118, 120.

Alternatively, it may also be conceivable that two hydraulic pumps may be provided, wherein each pump is assigned to or connected to the first or second line 118, 120.

The first hydraulic assembly 106 also contains a first line 118, which is connected to a first working chamber 122 of the steering gear housing 104.

Accordingly, the first hydraulic assembly 106 contains a second line 120, which is connected to a second working chamber 124 of the steering gear housing 104.

According to FIG. 1, it can be seen that the hydraulic pump 116 is connected to the first line 118 and to the second line 120.

The first line 118 therefore extends from a first pressure outlet of the hydraulic pump 116 to a connection of the steering gear housing 104 that opens into the first working chamber 122.

The second line 120 extends accordingly from a second pressure outlet of the hydraulic pump 116 to a connection of the steering gear housing 104 that opens into the second working chamber 124.

A hydraulic filter element may be arranged in each of the first and second lines 118, 120.

In addition, according to FIG. 1, a pressure sensor is arranged in the first line 118.

Furthermore, a pressure sensor and a temperature sensor are arranged in the second line 120.

In addition or alternatively, it is conceivable that a temperature sensor is arranged in the first line 118.

The first hydraulic assembly 106 also has a hydraulic tank, which can be fully or partially integrated into the first housing block 110.

Alternatively, it is also conceivable that the hydraulic tank is connected to the first housing block 110 by a flange.

The hydraulic tank is only schematically depicted on the basis of FIG. 1, so that it may also be conceivable that the hydraulic pump 116 is integrated into the tank.

Alternatively or additionally, it is also conceivable that the electric motor, the hydraulic tank, and the hydraulic pump 116 are flanged to each other and connected via suitable lines (not shown in FIG. 1).

The hydraulic tank is also assigned a pressure sensor and a temperature sensor for monitoring the pressure and temperature of the hydraulic oil in the tank.

The second hydraulic assembly 108 is in the form of a backup assembly and is connected to the steering gear 102 in a fault condition of the steering system 100.

Alternatively or additionally, the second hydraulic assembly 108 can be connected to the steering gear 102 in the form of a hydraulic flow connection in an inactive state of the steering system 100.

Connected here is to be understood as meaning that a continuous flow path is provided between the working chambers 122, 124 of the steering gear via the second hydraulic assembly 108.

The second hydraulic assembly 108 has components such as a hydraulic filter element 126 and a backup switching valve 128.

The hydraulic filter element 126 and the backup switching valve 128 form a series circuit.

The hydraulic filter element 126 is arranged upstream in relation to the backup switching valve 128.

A pressure sensor 144 for monitoring the filter condition and a bypass check valve or filter check valve 146 can be arranged parallel to the hydraulic filter element 126, wherein this arrangement can only be provided as an option.

The pressure sensor can be in the form of a differential pressure sensor or alternatively of two individual pressure sensors or pressure switches with adjustable pressure trigger thresholds.

The pressure sensors and temperature sensors of the first hydraulic assembly 106 described above and the pressure sensor 144 of the second hydraulic assembly 108 may be components of the operating parameter detection device 113 or may be connected to it via suitable signal lines.

The pressure sensor 144 described above and the electric motor M are further connected to the electronic control and/or regulation device 114 via suitable lines.

In addition, the second hydraulic assembly 108 has a further first line 130 and a further second line 132.

The further first line 130 is connected to the first working chamber 122 of the steering gear housing 104.

Accordingly, the further second line 132 is connected to the second working chamber 124 of the steering gear housing 104.

According to the illustration in FIG. 1, the backup switching valve 128 is switched into the conducting position in the inactive state or fault condition.

As a result, the first working chamber 122 and the second working chamber 124 are connected via the further first and second lines 130, 132 as well as via the hydraulic filter element 126 and the backup switching valve 128.

According to FIG. 1, the second hydraulic assembly 108 also has a bridge circuit 134, which has four outer branches 136 and a bridge branch 138, wherein the four outer branches 136 are connected to each other via four outer nodes 140.

The bridge branch 138 in turn is formed by the series circuit with the hydraulic filter element 126 and the backup switching valve 128.

As a result, the first working chamber 122 and the second working chamber 124 are connected to each other via the further first and further second lines 130, 132 and via the bridge circuit 134.

For this purpose, the bridge circuit 134 is connected by means of two outer nodes 140 to the further first line 130 and the further second line 132.

The bridge branch 138 in turn is connected to the two further outer nodes 140 of the bridge circuit which are not connected to the further first and second lines 130, 132.

An additional hydraulic filter element may be arranged in each of the further first and further second lines 118, 120.

The backup switching valve 128 is in the form of a 2/2-way solenoid valve and has a switch plunger and a solenoid coil for operating the plunger, wherein a change in the switching position of the switch plunger triggers an induced voltage in the solenoid coil.

Furthermore, according to the invention, a utility vehicle is provided (not shown in FIG. 1), which has the electro-hydraulic steering system 100 as described above.

The function of the steering system 100 according to the invention can now be described as follows:

The function of the operating parameter detection device 113 and the operating parameter determination device 115 is initially as follows:

According to the basic idea of the invention, the operating parameter determination device 115 is designed and/or set up for the purpose of determining and/or estimating at least one further assembly operating parameter of the first and/or second hydraulic assemblies 106, 108 on the basis of at least one detectable assembly operating parameter.

Detectable assembly operating parameters are in particular those operating parameters that can be detected by sensors or by means of the operating parameter detection device.

The detectable assembly operating parameter(s) include(s) a temperature of the hydraulic fluid in the first hydraulic assembly 106 and/or a pressure of the hydraulic fluid in the first hydraulic assembly 106.

Alternatively, the detectable assembly operating parameter(s) may include a temperature of the hydraulic fluid in the second hydraulic assembly 108 and/or a pressure of the hydraulic fluid in the second hydraulic assembly 108.

Accordingly, determinable assembly operating parameters are in particular those operating parameters that can be determined or estimated on the basis of the detectable operating parameter(s) (which can thus serve as input variables) of the operating parameter determination device.

A determinable assembly operating parameter includes a pressure of the hydraulic fluid in the second hydraulic assembly 108.

Preferably, the determinable assembly operating parameter includes an inlet pressure of the hydraulic fluid at the hydraulic filter element 126.

Alternatively or additionally, the determinable assembly operating parameter includes the outlet pressure of the hydraulic fluid at the hydraulic filter element 126.

Further alternatively or additionally, the determinable assembly operating parameter includes the inlet pressure and the outlet pressure of the hydraulic fluid at the hydraulic filter element 126.

Furthermore, the operating parameter detection device 113 is designed and/or set up to detect a motor operating parameter of the electric motor M and/or a pump operating parameter of the hydraulic pump 116.

The motor operating parameter(s) can be an electric motor current and/or an electric motor voltage and/or a motor speed and/or at least one motor power and/or at least one motor torque.

Accordingly, the pump operating parameter(s) can include a volume flow rate of the hydraulic fluid and/or a mass flow of the hydraulic fluid and/or a pump speed.

The operating parameter determination device 115 can also determine the electric motor power by multiplying the electric motor current and the electric motor voltage or the motor torque by a motor speed or motor angular velocity.

In addition, the operating parameter determination device 115 is in turn designed and/or set up to determine and/or estimate a determinable assembly operating parameter of the first and/or second hydraulic assemblies 106, 108 on the basis of the detected motor operating parameter and/or pump operating parameter.

More specifically, the operating parameter determination device 115 is designed and/or set up to determine and/or estimate the inlet pressure at the hydraulic filter element 126 on the basis of the electric motor current, the volume flow rate of the hydraulic fluid and the temperature of the hydraulic fluid.

Alternatively, the operating parameter determination device 115 may be designed and/or set up to determine and/or estimate the inlet and outlet pressure at the hydraulic filter element on the basis of the electric motor current, the volume flow rate of the hydraulic fluid and the temperature of the hydraulic fluid.

The operating parameter determination device 115 is also designed and/or set up to determine and/or estimate a filter operating condition in the form of a wear condition or the load condition of the hydraulic filter element 126 on the basis of the inlet pressure at the hydraulic filter element 126.

Alternatively, the operating parameter determination device 115 can also be designed and/or set up to determine and/or estimate the filter operating condition in the form of the wear condition or load condition of the hydraulic filter element 126 on the basis of the inlet and outlet pressure at the hydraulic filter element 126.

Further, a parameter model is implemented in the operating parameter determination device 115, by means of which the operating parameter determination device 115 is designed and/or set up to determine and/or estimate a corresponding assembly operating parameter of the second hydraulic assembly 108 on the basis of one or more detectable operating parameters as described above as an input variable.

Circuit diagram data are implemented In the parameter model, wherein in particular the circuit diagram arrangement according to FIG. 1 can be implemented as described above.

Accordingly, the circuit diagram data of the hydraulic circuit of components and lines of the first hydraulic assembly 106 and the second hydraulic assembly 108, which are stored in the operating parameter determination device 115 on the basis of a digital circuit diagram model, are assigned in accordance with FIG. 1.

The function of the operating parameter detection device 113 and the operating parameter determination device 115 in connection with the hydraulic circuit depicted in FIG. 1 is now as follows:

The steering gear 102 can be supplied with hydraulic fluid by the hydraulic pump 116.

In addition, the steering gear 102 can be controlled by the hydraulic pump 116 due to its different delivery directions.

To be more precise, the first working chamber 122 can be supplied with hydraulic fluid and controlled via the first line 118, since the first line connects this working chamber 122 to the hydraulic pump 116.

Accordingly, the second working chamber 124 can be supplied with hydraulic fluid and controlled via the second line 120, since the second line connects this working chamber 124 to the hydraulic pump 116.

The control is carried out by either the first working chamber 122 or the second working chamber 124—but not at the same time—of the steering gear being pressurized by the hydraulic pump 116.

The hydraulic pump 116 is therefore set up to pressurize the first line 118 according to the first delivery direction and the second line 120 according to the second delivery direction.

As soon as the hydraulic pump 116 is driven by the electric motor M (for example clockwise), it pressurizes the first line 118, which extends to the first working chamber 122, according to a first delivery direction.

Consequently, the hydraulic pump 116 and the steering gear 102 are connected to each other via the first line 118 and the connection of the steering gear 102, which is connected to the first line 118 and opens into the first working chamber 122, is pressurized.

As a result, the pressure in the first working chamber 122 increases and the piston is forced to a linear displacement movement, since there is a lower pressure in the opposite second working chamber 124, so that steering assistance is achieved.

The pressure in the opposite second working chamber 124 is therefore lower because this working chamber 124 is connected to the tank by the second line 120 and a corresponding return line (not shown in FIG. 1).

This means that the hydraulic oil can flow back into the tank from the second working chamber 124.

In this context, it is important to understand that the hydraulic pump 116 is only ever driven in one rotation direction and therefore only the first or the second line 118, 120 can be pressurized.

If the rotation direction of the hydraulic pump 130 is reversed, the previously described connection or case occurs in exactly the opposite order, as described below:

As soon as the hydraulic pump 116 is driven by the electric motor M (for example counterclockwise), it pressurizes the second line 120, which extends to the second working chamber 124, in accordance with a second delivery direction.

Consequently, the hydraulic pump 116 and the steering gear 102 are connected to each other via the second line 120 and the connection of the steering gear 102, which is connected to the second line 120 and opens into the second working chamber 124, is pressurized.

As a result, the pressure in the second working chamber 124 increases and the piston is forced to a linear displacement movement, since there is now a lower pressure in the opposite first working chamber 122, so that steering assistance is achieved.

The pressure in the opposite first working chamber 122 is therefore lower, because this working chamber 122 is connected to the tank via the first line 118 and a corresponding return line (not shown in FIG. 1).

This means that the hydraulic oil can flow back into the tank from the first working chamber 122.

In this context, it is important to understand that the hydraulic pump 116 is only ever driven in one rotation direction at a time and therefore only the first or the second line 118, 120 can be pressurized.

The above function of the steering system 100 has been described in accordance with a normal operating state, wherein the following functional description explains an inactive state of or a fault condition of the system:

In this state, the backup switching valve 128 is in the conducting switching position shown in FIG. 1.

This position allows an uninterrupted flow path from the first working chamber 122 to the second working chamber 124 via the further first and further second lines 130, 132 and via the bridge circuit 134.

The flow direction of the hydraulic oil depends on the pressure gradient between the first and second working chambers 122, 124.

The pressure gradient can only be caused by a manual steering movement of the steering shaft because the steering shaft provides the linear displacement movement of the steering gear piston (in this case there is no pressurizing by the hydraulic pump 116), wherein this case is assigned to the fault condition.

In addition, or alternatively, the pressure gradient can be formed as described above by the selective pressurization of the first or second working chamber 122, 124 by the hydraulic pump 116, wherein this case is assigned to an inactive state of the steering system.

The inactive state is the state wherein the steering system is inactive, i.e. when either the utility vehicle is currently not in motion or the utility vehicle is in motion and no steering assistance is required in the future.

In this case, the operating parameter detection device 113 can detect the corresponding operating parameters of the first and second assemblies 106, 108 as described above and transmit them to the operating parameter determination device.

In particular, the operating parameter determination device 115 can determine or estimate the inlet pressure at the hydraulic filter element 126 from the detected operating parameters and from this can determine its wear condition or blockage state or load condition.

If there is greater pressure in the first working chamber 122 than in the second working chamber 124, this results in the following flow path or a hydraulic flow through the following components:
first further line 130 (if appropriate, hydraulic filter in this line);
outer node 140, which connects the bridge circuit 134 and a further first line 130;
outer branch 136 conductive in the flow direction (clearly defined by check valve arrangement);
bridge branch 138, another outer branch 136 conductive in the direction of flow, which connects the bridge branch 138 to the outer node 140 connected to the further second line 132;
further second line 132; and
second working chamber 124.

If there is a greater pressure in the second working chamber 124 than in the first working chamber 122, the following flow path or a hydraulic oil flow through the following components results from this:
first further line 132 (if appropriate, a hydraulic filter in this line);
outer node 140, which connects the bridge circuit 134 and the further second line 132;
outer branch 136 conductive in the direction of flow (clearly defined by check valve arrangement);
bridge branch 138;
further outer branch 136, which is conductive in the direction of flow, which connects the bridge branch 138 to the outer node 140 connected to the further first line 130;
further first line 130; and
first working chamber 122.

These two flow paths described above allow the hydraulic oil to be cleaned by the hydraulic filter element 126, which is the main filter element.

In this respect, the hydraulic oil can be cleaned very efficiently in an inactive state of the steering system, as the pressures required for this are much lower than for steering assistance.

This is because these pressures for cleaning must not cause the steering gear piston to be actuated so strongly that this would trigger an actual steering movement or steering assistance, so that the pressures must remain below a corresponding pressure threshold.

However, due to friction and inertia in the steering system, cleaning below this previously described pressure threshold is quite possible, so that if the steering system 100 is expected to be inactive in the future, cleaning very efficiently by the hydraulic filter element 126 is possible.

### LIST OF REFERENCE SIGNS

100 Electro-hydraulic steering system
102 Steering gear, especially spindle gear
104 Steering gear housing
106 First hydraulic, especially electro-hydraulic, assembly
108 Second hydraulic, especially electro-hydraulic, assembly
110 First housing block
112 Second housing block
113 Operating parameter detection device
114 Electronic control and/or regulation device
115 Operating parameter determination device
116 Hydraulic pump
118 First line
120 Second line
122 First working chamber
124 Second working chamber
126 Hydraulic filter element
128 Backup switching valve
130 Further first line
132 Further second line
134 Bridge circuit
136 Outer branch
138 Bridge branch
140 Outer node
142 Check valve
144 Pressure sensor
146 Filter check valve
M Electric motor

1. An electro-hydraulic steering system for a vehicle, in particular a utility vehicle, comprising:
at least one steering gear, in particular a spindle steering gear;
at least one first hydraulic, in particular electro-hydraulic, assembly by means of which the steering gear can be supplied with hydraulic fluid and/or controlled;
at least one second hydraulic, especially electro-hydraulic, assembly, which can be connected to the steering gear;
at least one operating parameter detection device for detecting at least one detectable assembly operating parameter of the first and/or second hydraulic assembly; and
at least one operating parameter determination device,
wherein the operating parameter determination device is designed and/or set up to determine and/or estimate at least one further assembly operating parameter of the first and/or second hydraulic assembly in the form of a determinable assembly operating parameter on the basis of at least one detectable assembly operating parameter.

2. The electro-hydraulic steering system as claimed in claim 1, wherein the first hydraulic assembly has at least one hydraulic pump and at least one electric motor for driving the hydraulic pump,
wherein the operating parameter detection device is designed and/or set up to detect at least one motor operating parameter of the electric motor and/or at least one pump operating parameter of the hydraulic pump, and
wherein the operating parameter determination device is designed and/or set up to determine and/or estimate at least one determinable assembly operating parameter of the first and/or second hydraulic assembly on the basis of the detected motor operating parameter and/or pump operating parameter.

3. The electro-hydraulic steering system as claimed in claim 2, wherein the motor operating parameter(s) include(s) at least one electric motor current and/or at least one electric motor voltage and/or at least one motor speed and/or at least one motor power and/or at least one motor torque.

4. The electro-hydraulic steering system as claimed in claim 2, wherein the pump operating parameter(s) include(s) at least one volume flow rate of the hydraulic fluid and/or at least one mass flow of the hydraulic fluid and/or at least one pump speed.

5. The electro-hydraulic steering system as claimed in claim 1, wherein the detectable assembly operating parameter(s) include(s) at least one temperature of the hydraulic fluid in the first hydraulic assembly and/or at least one pressure of the hydraulic fluid in the first hydraulic assembly.

6. The electro-hydraulic steering system (100) as claimed in claim 1, wherein the detectable assembly operating parameter(s) include(s) at least one temperature of the hydraulic fluid in the second hydraulic assembly and/or at least one pressure of the hydraulic fluid in the second hydraulic assembly.

7. The electro-hydraulic steering system as claimed in claim 1, wherein the determinable assembly operating parameter(s) include(s) at least one pressure of the hydraulic fluid in the second hydraulic assembly.

8. The electro-hydraulic steering system as claimed in claim 1, wherein the second hydraulic assembly is in the form of a backup assembly and has at least one hydraulic filter element and at least one backup switching valve.

9. The electro-hydraulic steering system as claimed in claim 8, wherein the determinable assembly operating parameter(s) include(s) at least one inlet pressure and/or outlet pressure of the hydraulic fluid at the hydraulic filter element.

10. The electro-hydraulic steering system as claimed in claim 8, wherein the operating parameter determination device is designed and/or set up to determine and/or estimate at least one inlet and/or outlet pressure at the hydraulic filter element at least on the basis of the electric motor current, the volume flow rate of the hydraulic fluid and the temperature of the hydraulic fluid, and in particular the pump speed and/or the motor speed.

11. The electro-hydraulic steering system as claimed in claim 10, wherein the operating parameter determination device is designed purpose and/or set up to determine and/or estimate a filter operating condition, in particular a wear condition or a load condition, of the hydraulic filter element at least on the basis of the inlet and/or outlet pressure at the hydraulic filter element.

12. The electro-hydraulic steering system as claimed in claim 1, wherein in the operating parameter determination device a parameter model is implemented, by means of which the operating parameter determination device is designed and/or set up to determine and/or estimate at least one assembly operating parameter of the first and/or second hydraulic assembly at least on the basis of a detectable operating parameter as an input variable.

13. The electro-hydraulic steering system as claimed in claim 12, wherein in the parameter model, circuit diagram data are implemented that can be associated with a hydraulic circuit of components and lines of the first hydraulic assembly and the second hydraulic assembly.

14. A vehicle, in particular a utility vehicle, with at least one electro-hydraulic steering system as claimed in claim 1.
